(19) United States
(12) Patent Application Publication
(10) Pub. No.: US 2020/0205402 A1
(43) Pub. Date: Jul. 2, 2020

(54) NON-LEECHING ANTI-MICROBIAL TEXTILE

(71) Applicants: Jerry Gaskins, Short Hills, NJ (US); Wayne Krause, Newnan, GA (US)

(72) Inventors: Jerry Gaskins, Short Hills, NJ (US); Wayne Krause, Newnan, GA (US)

(21) Appl. No.: 16/612,661

(22) PCT Filed: May 12, 2017
(86) PCT No.: PCT/US17/32419

§ 371 Date: Nov. 11, 2019

(51) Int. Cl. A01N 25/10; A01N 25/34; A01N 59/16; C08K 3/08; C08K 9/02; C08K 3/36; D01F 1/10; D01D 5/08; D01F 8/14

(52) U.S. Cl. CPC A01N 25/10; A01N 25/34; A01N 59/16; C08K 3/08; C08K 9/02; C08K 2201/005; D01F 1/103; D01D 5/08; D01F 8/14; C08K 2201/011; C08K 2003/0806; C08K 3/36

(57) ABSTRACT

A non-leeching textile having inherent anti-microbial properties is disclosed. The textile employs metal nanoparticles, preferably silver-silica nanoparticles, to obtain its inherent anti-microbial properties. Notably, the textile only requires minimal amounts of metal nanoparticles in order to achieve biocidal or biostatic functionality. The metal nanoparticles are integrated into a matrix of the textile, preventing the metal nanoparticles from leeching out of the textile.

### CLAIM OF PRIORITY

This application is a U.S. national phase application of International Application No.: PCT/US17/32419, entitled “NON-LEECHING ANTIMICROBIAL TEXTILE”, filed on May 12, 2017, the contents of which are hereby incorporated by reference, in their entirety.

### NOTICE OF COPYRIGHTS AND TRADE DRESS

A portion of the disclosure of this patent document contains material which is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### FIELD OF THE EMBODIMENTS

The field of the present invention and its embodiments relate to a non-leeching anti-microbial textile which has a low risk profile. In particular, the present invention and its embodiments relate to a textile that is inherently anti-microbial through the use of metal nanoparticles, which are in an oxidation state such that they will not leech due to contact with water.

### BACKGROUND

Ever since 1876, when Robert Koch discovered the link between microorganisms and diseases, humanity has been interested in various methods for eliminating said microorganisms. Since then, scientists have developed a variety of methods for reducing the loads of microorganisms on various surfaces. Various chemicals have been developed to achieve this goal, but the inherent anti-microbial properties of certain metals provide a robust anti-microbial mechanism due to what is called the oligodynamic effect. Many metals exhibit anti-microbial properties, and silver has been identified as a promising candidate. While the discovery of antibiotics led to a reduction in the use of silver as an anti-microbial, the rise of antibiotic-resistant strains of bacteria began a resurgence in this use of silver, in particular the use of silver nanoparticles.

The use of silver as an anti-microbial applies to many different technical areas and has been used in ways such as imbuing medical devices with silver, or coating fabrics with a silver-based anti-microbial material. It has been shown that this use of silver has meaningfully reduced the bacterial count of said devices.

These anti-microbial textiles are produced by a variety of methods, each with its own respective drawbacks. One popular method consists of taking a pre-spun fiber and coating this fiber with an anti-microbial substance such as a silver nanoparticle, and then subsequently making a textile with that fiber. However, the silver nanoparticles used in these textiles employ ionic silver, which leeches silver ions into any water that comes in contact with these devices. This makes anti-microbial textiles produced this way difficult to safely and responsibly clean. As can be expected, this limitation has greatly inhibited the effective use of anti-microbial textiles, which must be washed regularly.

Specifically, today, anti-microbial fabrics that are coated with silver or silver nanoparticles operate by generating silver ions that interrupt the functions of any microbe that comes into contact with these ions. A number of mechanisms have been posited as to how silver ions interact with microbes, such as protein inactivation and disruption of DNA replication. As mentioned, while the use of silver ions is an effective method of reducing microbial load, silver ions (Ag⁺) are readily-soluble in water, which makes them unsuitable for wide-spread use in clothing, due to silver ions leeching into the water supply.

In an attempt to address silver ions leeching into water supplies, the Environmental Protection Agency has released guidelines entitled “Secondary Drinking Water Standards: Guidance for Nuisance Chemicals.” These guidelines, among other things, dictate that silver cannot be present in amounts above 0.1 mg/L, a very low concentration, lest the drinkers of that water experience skin discoloration or discoloration of the sclera. As such, there is a need for an anti-microbial textile that contains metals that will not leech into the water supply when washed.

It should be noted that metal nanoparticles that exhibit anti-microbial properties without leeching metal ions into water that comes in contact with said metal nanoparticles have been taught in U.S. Pat. Nos. 7,893,104 and 8,318,698, which are not admitted to be prior art with respect to the present disclosure by its mention in this Background Section. Despite these teachings, to date, no one has been able to successfully incorporate these particles into textiles while keeping the metal in the metal nanoparticles in the elemental state. As such, the teachings disclosed herein represent a meaningful improvement over the current state of the art of anti-microbial textiles.

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

For at least the foregoing reasons, there is a need for an anti-microbial textile that is effective and does not leech metal ions when exposed to water, and that can achieve anti-microbial activity at safe loads of said metal.

### SUMMARY

The present disclosure provides for a textile that satisfies this need. The textile exhibits inherent anti-microbial properties, the textile comprising at least one extruded component having a matrix, where a plurality of metal nanoparticles are integrated into this matrix. The metal nanoparticles are present in this matrix in amounts in the range of 10 ppm to 100 ppm. Preferably, the metal nanoparticles are present in the textile in amounts in the range of 19 ppm to 30 ppm. Depending on the embodiment, the textile in accordance with the present disclosure may be biostatic or biocidal.

In various embodiments, the metal nanoparticles range in size from 1 to 100 nanometers, but the preferred range of the size of the metal nanoparticles is 19 to 33 nanometers. While many metal nanoparticles are suitable for use with the present invention, in a highly-preferred embodiment the metal nanoparticles are silver-silica nanoparticles as taught by U.S. Pat. Nos. 7,893,104 and 8,318,698.

Due to the novel ability of being able to incorporate anti-microbial metal nanoparticles into the matrix of the extruded component, the technology of the present disclosure can be used to create a wide variety of materials. If the desired material is not to be blended, the extruded component is a filament. This filament may be spun into a yarn with a denier in the range of 1 to 1200. If the desired material is to be a blend of the extruded component and an inert material, the extruded component will be a fiber which is subsequently combined with the inert material. In a highly-preferred embodiment, the extruded component is at least 50% of the textile, by weight. Preferably, the extruded component is a thermoplastic polymer, regardless of whether it is fashioned into a filament or a fiber. In many embodiments, the fiber according to the present disclosure has a staple length, which is in the range of 29/32 inches, to 59/25 inches.

The present disclosure also provides for a textile that is used to produce finished fabrics that exhibit anti-microbial, anti-fungal, and odor-reducing properties. This textile is comprised of at least one extruded component having a matrix; and a plurality of metal nanoparticles integrated into the matrix, where the metal nanoparticles are present in the matrix in amounts in the range of 10 ppm and 100 ppm, and where the metal nanoparticles are present in the textile in amounts in the range of 19 ppm and 30 ppm.

Unlike traditional metal-nanoparticle-based anti-microbial coatings, the textile according to the present disclosure exploits the catalytic properties of elemental silver to generate reactive free radical oxygen through the dissociation of molecular oxygen in the environment into said radical form. Further, the present disclosure provides for textiles that are inherently anti-microbial. That is, the textile in accordance with the present disclosure is not coated with an anti-microbial; the matrix of the extruded component has anti-microbial metal nanoparticles incorporated with the monomers. When these free radicals make contact with other particles, these generated oxygen radicals will either re-stabilize into molecular oxygen or damage cell walls/membranes of the microorganisms. As Lok, et al. (2007, J. Biol. Inorg. Chem. 12(4):527-34.) has shown that elemental silver is not suitable for use as an anti-microbial agent, the effectiveness of the textile according to the present disclosure is very unexpected. This teaching against the use of elemental silver as an anti-microbial agent has been confirmed by Rai, et al. (2012, J. Appl. Microbiol. 112:841-852).

These and other features, aspects, and advantages of the present invention will become better understood with reference to the following description and appended claims.

### DETAILED DESCRIPTION OF THE PREFERRED EMBODIMENTS

In the Summary above, in the Detailed Description, and in the Claims below, reference is made to particular features of the invention. It is to be understood that the disclosure of the invention in this specification includes all possible combinations of such particular features. For example, where a particular feature is disclosed in the context of a particular aspect or embodiment of the invention, or of a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

### Definitions

“Filament” is defined as a single extruded polymer, such as polyethylene or polyurethane.

“Fiber” is defined as one or more filaments as defined above, optionally combined with an inert material such as cotton.

“Matrix” refers to a polymer framework having non-polymer particles incorporated therein.

“Staple Cloth” refers to a fiber or filament of a discrete length.

“Textile” is defined as a finished fabric constructed out of one or more fibers, filaments, or some combination thereof.

Preparation of Textiles

The textiles in accordance with the present disclosure can be prepared via the following steps. Note that the overall batch size may vary, and that the following steps are one example of how to prepare textiles in accordance with the present disclosure.

The preparation of the textiles begins with the preparation of a silica-sulfur-silver complex. The complex is composed of silver nanoparticles attached to larger amorphous silica via a thiolate bond, suspended in a water/ethylene glycol mixture. One suitable amorphous silica is food-grade SiO₂ particles. The particles in the complex have a mean particle size ranging from 30-50 nanometers, and contain a mean concentration of silver ranging from 10,000 to 12,000 milligrams of silver per kilogram of suspension.

The silver-sulfur-silica complex is prepared by using a gram scale, such as an Ohaus® Scout Balance Scale, weighing out 1018 grams of deionized water. The water can be deionized by a device such as Kaiyuan® Model No. RO-250/H water deionizer. This deionized water is added to a retort vessel equipped with a hemispherical heater, such as an Across International® Model No. R20 jacketed glass reactor. Then 2035 grams of Silica Sol (solid content of 50% by weight) is added to the water and then the entire solution is heated to 40° C. After the solution has been heated, 54 grams of 3-mercaptoproyltrimethoxysilane (MPTMS) is then added to the mixture and is stirred moderately for 25 minutes. 102 grams of Silver Nitrate (AgNO₃), 475 grams of ethylene glycol, and 1696 grams of deionized water are then added to the mixture over roughly 15 minutes while being stirred at approximately 60 revolutions per minute. The mixture is then homogenized by stirring for an additional 20 minutes at 120 revolutions per minute. The above steps, collectively, are an improved synthesis from the one disclosed and discussed at length in U.S. Pat. Nos. 7,893,104 and 8,318,698, the contents of both of which are hereby incorporated by reference.

After the silver-sulfur-silica complex has been prepared, the polymeric intermediate must be prepared. Such preparation begins with pre-blending 3.5% by weight of silver-sulfur-silica of silica-sulfur-silver complex (containing 12,000 milligrams of silver per kilogram of solution) with a low-melt PBT base polymer. Preferably, approximately 175 grams of the silver-sulfur-silica complex will be blended with 50 kilograms of the low-melt PBT base polymer. A gram scale such as the Ohaus® Scout Balance Scale could be used for scaling these quantities out.

This base polymer may be in the form of a liquid, powder, granule, chip, or pellet, provided that the base polymer has a melt-flow temperature compatible with the melt-flow temperature of the polymer selected to produce the finished textile. Such polymers can include PET, PBT, Nylon and PP.

The mixture is then weighed using a kilogram scale and is placed into a common stainless-steel shear-blade blender. The mixture is subsequently blended for 20 mins to form a homogenous mixture (surface coating of the base polymer). The homogenous mixture is then conveyed to a desiccant dryer such as a Conair® W Dryer series plastic pellet dryer, and is dried to the desired moisture level of 0.005%. This process can take between 4-6 hours depending on the size and range of the drier used. The dried sample is analyzed via a moisture analyzer such as the Sartorius-Omnimark®, Mark 3 HP plastic moisture analyzer.

The dried mixture is then loaded into a gravimetric feeding system like the Conair® Model TWB30-4, where it is fed into a high-performance compounder for molten-state blending. This process typically has a throughput of 50 to 6,000 kilograms/hour and the processing temperature is approximately 180° C. The molten state blend is then extruded into strands at a preferred rate of 350-450 kilograms/hour. As the molten plastic passes through a forming die, the extruded component is conveyed into water cooling tanks. The strands will have a silver content of approximately 420 ppm. The extruded component shall have a matrix, as all polymers do, however, the extruded component in accordance with the present invention will be a combination of the monomers of the base polymer, and the silver-sulfur-silica complex as described above.

This process also contains the optional step of allowing the extruded component to air-dry so that the extruded component can be cut up into pellets. The size of the pellet is largely arbitrary but should be substantially the same size as the non-treated pellet used in subsequent processing so that the pellets may be used in existing manufacturing processes without much alteration so the processes.

The polymeric intermediate can be used to create filament yarn, staple fiber, tow, and fiberfill all exhibiting anti-microbial properties due to the presence of elemental silver. The polymeric intermediate is used in standard industrial processes for preparing the filament yarn, staple fiber, tow, and fiberfill by substituting the polymer used with the polymeric intermediate. The polymeric intermediate can completely replace the polymer, or can partially replace the polymer, depending on the desired final product. Interestingly, the use of ionic silver would be unsuitable here as ionic silver breaks down at 150° C., while elemental silver doesn't break down until it reaches 450° C., which is similar to the degradation temperature of polyester, one of the suitable polymers to be used in accordance with the teachings contained herein.

To create filament, the extruded component is fed directly into any standard melt spinner containing an amount of inert polymer, such as polyester. By “inert” it is meant that the material exhibits no or de minimus anti-microbial activity. When the extruded component is homogenized with the inert material, it can be drawn into filament which can be used to fashion a textile having anti-microbial properties that will not leech silver in the presence of water.

Further, this filament can be spun with other inert materials such as cotton to create a polyester blend that still exhibits anti-microbial properties without leeching silver in the presence of water. This can be achieved using standard industry processes that blend polyester filament with filaments of other materials to create a polyester-blended fiber which can be used to produce textiles. These fibers can also be spun into staple fibers which can also be used to create textiles using standard industry processes known by a person having ordinary skill in the art.

Wash Test

Tests were performed to determine the amount of metal that was leeched from various embodiments of the present invention. Both a laundry wash test and a saliva wash test were performed. For the laundry wash test, a modified version of the ISO 105-C06 “Colorfastness to domestic and commercial laundering” standard was used, where the steel balls that are typically used were replaced with rubber balls having a durometer hardness of 70, in compliance with AATCC Test Method 61. The steels balls were replaced due to the fact that prior experiments have shown that the use of steel balls results in the loss of silver. This is due to the silver coming in contact with the steel balls, thus tainting the results of the test. As such, rubber balls, which will not yield any loss of silver, were used. Note that the size of the sample taken from the tested textiles was doubled to preserve the same washing-to-textile area ratio mandated by the ISO 105-C06. An untreated textile constructed out of 100% polyester processed with the same modified ISO Colorfastness test served as a control here.

Specifically, the laundry wash test consisted of the following steps: First, 150 ml of a washing solution, comprised of distilled water with ±0.01 g L-¹ ECE detergent, having a pH of 10.6, and ten rubber balls were added into each of three separate stainless steel containers. The filled containers were then preheated to 40° C. in the washing machine for a period of 45 minutes (±5 min). After being preheated, one treated textile sample was added into each stainless steel container and washed for 30 minutes at 40 (±2° C.). Each textile sample measured 8 cm×20 cm and had a weight of approximately 2.75 grams. The weight of each textile was determined from the average weight of three textile samples. Each textile sample was then removed from the stainless steel container and wrung so that residual washing solution in the textile sample was returned to the stainless steel container. All the wash solutions were subsequently transferred into high-density polyethylene bottles. While still wet, each textile sample was then placed into one of three new stainless steel containers filled with 20 mL (±0.03 mL) of water and was rinsed for 5 min via a washing machine. The rinse process was completed a second time in a new container and with new rinse water. The two collected rinsing solutions were then combined and placed into an additional high-density polyethylene bottle. The textile samples were dried and packaged into plastic bags labeled with the appropriate textile sample identification number.

For the saliva wash test, the same process as the above wash test was used, except a saliva solution was used instead of the washing solution. The saliva solution is water dosed with a plurality of salts. The salts and their concentrations are listed in Table 1, below.

TABLE 1

| Component | Concentration |
|---|---|
| Sodium chloride (NaCl) | 125.6 |
| Potassium chloride (KCl) | 963.9 |
| Potassium thiocyanate (KSCN) | 189.2 |
| Urea (CH₄N₂O) | 200.0 |
| Sodium sulfate decahydrate (NaSO₄) | 763.2 |
| Ammonium chloride (NH₄Cl) | 178.0 |
| Calcium chloride dihydrate (CaCl₂) | 227.8 |
| Monopotassium phosphate (KH₂PO₄) | 654.5 |
| Sodium bicarbonate (NaHCO₃) | 630.8 |

All wash and rinse solution samples were suction filtered using separate Advantec® cellulose nitrate membrane with a pore size of 0.45 μg. These membranes were placed in the housing of a filtration apparatus, collecting any residue in the solutions, which was filtered in 10 mL portions. This residue was subsequently prepared for digestion. The filtered solution was placed into a sealed test tube for further processing by microwave digestion.

The washed textiles were cut into a plurality of pieces approximately 3×3 mm pieces. These pieces were then weighed and subsequently transferred to a microwave vessel. In this vessel, 3 mL of 6N HNO₃ was added, and the vessel was placed into a CEM microwave digester. The microwave digester operates by increasing the temperature of each sample to at least 175° C. in approximately 5.5 minutes and holding that temperature for an additional 4.5 minutes. The pieces were allowed to cool for 5 minutes before being removed from the digester. After digestion, the control was transferred to a 10 mL volumetric flask and diluted to 10 mL with deionized water. The treated textiles were transferred to a 25 mL volumetric flask and diluted to 25 mL with deionized water.

The membranes used to filter the wash solutions were also processed. To start, they were dried to a constant weight at 105° C. and were subsequently cut into pieces approximately 3×3 mm in size. The pieces were transferred to a microwave vessel where 3 mL of 6N HNO3 was added, and the vessel was placed in a CEM microwave digester. The microwave digester operates by increasing the temperature of each sample to at least 175° C. in approximately 5.5 minutes and holding that temperature for an additional 4.5 minutes. The pieces were allowed to cool for 5 minutes before being removed from the digester. After digestion, the pieces were transferred to a 10 mL volumetric flask and diluted to 10 mL with deionized water.

Wash Results

After the above processing of the textiles, wash solutions, and membranes, analysis was conducted using an Agilent® 7700X inductively coupled plasma mass spectrometer (ICP-MS). Performing the ICP-MS on all of the textiles, wash solutions, and membranes resulted in the following aggregated data. Table 2 shows the information for the laundry wash test. Table 3 shows the information for the saliva wash test.

TABLE 2

| | |
|---|---|
| Total Silver Detected in Textiles Before | 66.54 μg (Stdev - 2.27) |
| Washing | |
| Total Silver Detected in Wash Solution: | 0.08 μg (Stdev - 0.05) |
| Total Silver Detected in Rinse Solution | 0.04 μg (Stdev - 0.02) |
| Total Silver Detected in Textiles After | 64.63 μg (Stdev - 3.03) |
| Washing | |
| Total Silver Released as a Result of | 0.12 μg (Stdev - 0.06) 0.17% |
| Test | |
| Total Silver Released <450 nm | 0.11 μg (Stdev - 0.06) 0.16% |
| Total Silver Released >450 nm | 0.01 μg (Stdev - 0.01) 0.02% |

TABLE 3

| | |
|---|---|
| Total Silver Content of Textiles Before | 94.9 μg (Stdev - 4.39) |
| Washing | |
| Total Silver Content of Wash Solution | 0.10 μg (Stdev - 0.13) |
| Total Silver Content of Textiles After | 94.42 μg (Stdev - 4.88) |
| Washing | |
| Total Silver Released as a Result of | 0.10 μg (Stdev - 0.13) 0.11% |
| testing | |
| Total Silver Released <450 nm | 0.10 μg (Stdev - 0.13) 0.11% |
| Total Silver Released >450 nm | 0.00 μg (Stdev - 0.00) 0.00% |

Anti-Microbial Test

The anti-microbial properties of the textiles in accordance with the present disclosure were tested against a variety of pathogens using the ASTM E 2180-07 (Standard Test Method for Determining the Activity of Incorporated Anti-microbial Agent(s) in Polymeric or Hydrophobic Materials) and AATCC Test Method 100-2012 (Antibacterial Finished on Textile Materials: Assessment of), the contents of both of which are hereby incorporated by reference. The results of the test are listed in Table 4, below.

TABLE 4

| Line | Sample | Test | Test | Test |
|---|---|---|---|---|
| Item | Description | Method | Organism | Results |
| 1 | 100% | ASTM 2180-7 | Staphylococcus | 99.99% |
| | Polyester | | aureus | |
| | Textile | | | |
| 2 | 100% | ASTM 2180-7 | Staphylococcus | 99.99% |
| | Polyester | | aureus | |
| | Textile | | | |
| 3 | 100% | ASTM 2180-7 | Staphylococcus | 99.99% |
| | Polyester | | aureus | |
| | Textile | | | |
| 4 | 100% | ASTM 2180-7 | Staphylococcus | 99.96% |
| | Polyester | | aureus | |
| | Textile | | | |
| 5 | 100% | ASTM 2180-7 | Staphylococcus | 99.99% |
| | Polyester | | aureus | |
| | Textile | | | |
| 6 | 100% | ASTM 2180-7 | Staphylococcus | 99.99% |
| | Polyester | | aureus | |
| | Textile | | | |
| 7 | 100% | AATCC 100-12 | Staphylococcus | 99.80% |
| | Polyester | | aureus | |
| | Textile | | | |
| | | | Klebsiella | 99.00% |
| | | | pneumoniae | |
| 8 | 95/5 Poly- | AATCC 100-12 | Staphylococcus | 99.90% |
| | spandex | | aureus | |
| | Textile | | | |
| | | | Klebsiella | 99.90% |
| | | | pneumoniae | |
| 9 | 65/35 Poly- | AATCC 100-12 | Staphylococcus | 99.90% |
| | cotton | | aureus | |
| | | | Klebsiella | 99.90% |
| | | | pneumoniae | |
| 10 | 65/35 Poly- | AATCC 100-12 | Staphylococcus | 99.60% |
| | Cotton | | aureus | |
| | (Sample 1) | | | |
| | | (2 Hour | Klebsiella | 99.10% |
| | | Exposure) | pneumoniae | |
| 11 | 65/35 Poly- | | Staphylococcus | 99.70% |
| | Cotton | | aureus | |
| | (Sample 2) | | | |
| | | | Klebsiella | 99.20% |
| | | | pneumoniae | |
| 12 | 65/35 Poly- | ASTM 2180-7 | Staphylococcus | 99.10% |
| | Cotton | | aureus | |
| 13 | Non-woven | ASTM 2180-7 | Staphylococcus | 96.40% |
| | | | aureus | |
| 14 | EVA | ASTM 2180-7 | Staphylococcus | 99.99% |
| | | | aureus | |
| | | | Klebsiella | 99.99% |
| | | | pneumoniae | |
| 15 | EVA | ASTM 2180-7 | Staphylococcus | 99.99% |
| | | | aureus | |
| 16 | EVA | ASTM G 21-09 | Trichophyton | 0 Grade |
| | | | mentagrophytes | |
| 17 | EVA | ASTM 2180-7 | Staphylococcus | 99.99% |
| | | | aureus | |
| 18 | Polypro | ASTM 2180-7 | Staphylococcus | 99.90% |
| | | | aureus | |
| 19 | HOPE | ASTM 2180-7 | Staphylococcus | 99.60% |
| | | | aureus | |
| 20 | Polyester | ASTM 2180-7 | Staphylococcus | 99.80% |
| | Fiber | | aureus | |
| 21 | Polyester | ASTM 2180-7 | Staphylococcus | 99.90% |
| | Fiber | | aureus | |
| 22 | P.U. Foam | ASTM 2180-7 | Staphylococcus | 99.99% |
| | | | aureus | |

As can be seen, the textiles in accordance with the present disclosure exhibit strong anti-microbial properties while being non-leeching in both water and saliva. Specifically, the ability to remove 99.99% of Staphylococcus aureus, the bacterium that causes MRSA, as well as 99.9% of Klebsiella pneumoniae, another leading cause of infections, in both a 100% polyester textile and a poly-cotton blend textile offers a dramatic improvement over existing technologies.

In some embodiments, the textiles in accordance with the present disclosure also have inherent anti-counterfeiting properties. By probing the silver content in any knock-offs, it is possible to determine whether a textile employs the teachings of this disclosure or not.

Further, the fact that teachings in the art expressly stated that silver ions are required for silver nanoparticles to exhibit anti-microbial properties, yet the textiles descripted above exhibit anti-microbial properties while employing elemental silver, a highly unexpected result has been achieved. This is complemented by the fact that the textiles in accordance with the present disclosure also do not leech silver ions into water provides strong evidence of a highly unexpected result.

Although the present invention has been described in considerable detail with reference to certain preferred versions thereof, other versions are possible. Therefore, the spirit and scope of the appended claims should not be limited to the description of the preferred versions contained herein.

1. A textile that exhibits inherent anti-microbial properties, comprising:
at least one extruded component having a matrix; and
a plurality of silver-silica nanoparticles containing elemental silver integrated into the matrix,
wherein the silver-silica nanoparticles are present in the matrix in amounts in the range of 10 ppm to 100 ppm, and
wherein the textile does not leach silver ions in the presence of water.

2. The textile of claim 1, wherein the silver-silica nanoparticles are present in the textile in the amount of 19 ppm.

3. The textile of claim 2, wherein the textile is biostatic.

4. The textile of claim 2, wherein the textile is a biocidal.

5. The textile of claim 2, wherein the silver-silica nanoparticles range in size from 1 to 100 nanometers.

7. The textile of claim 5, wherein the extruded component is a filament.

8. The textile of claim 5, wherein the extruded component is a fiber.

9. The textile of claim 7, wherein the filament is a thermoplastic polymer.

10. The textile of claim 8, wherein the fiber has a staple length, wherein the staple length ranges from 3683/1600 centimeters to 7493/1250 centimeters.

11. The textile of claim 8, wherein the fiber is a thermoplastic polymer.

12. The textile of claim 9 or 10, wherein the extruded component is spun into a yarn.

13. The textile of claim 11, wherein the extruded component is blended with an inert material.

14. The textile of claim 11, wherein the yarn has a denier in the range of 1 to 1200.

15. The textile of claim 12, wherein the extruded component is at least 50% of the textile, by weight.

16. A textile used to produce finished fabrics that exhibit anti-microbial, anti-fungal, and odor-reducing properties, comprising:
at least one extruded component having a matrix; and
a plurality of silver-silica nanoparticles containing elemental silver integrated into the matrix,
wherein the silver-silica nanoparticles are present in the matrix in amounts in the range of 10 ppm to 100 ppm.

17. The textile of claim 16, wherein the silver-silica nanoparticles are present in the textile in the amount of 19 ppm.
